(19) United States
(12) Patent Application Publication
(10) Pub. No.: US 2005/0141451 A1
(43) Pub. Date: Jun. 30, 2005

(54) Channel time allocation method in WPAN

(75) Inventors: Won-yong Yoon, Seongnam-si (KR); Yong-suk Kim, Seo-gu (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/024,828

(22) Filed: Dec. 30, 2004

(30) Foreign Application Priority Data
Dec. 30, 2003 (KR) 2003-99745

(51) Int. Cl. H04Q 7/00; H04J 3/06

(52) U.S. Cl. 370/329; 370/350

(57) ABSTRACT

A channel time allocation method in a wireless network which is synchronized by a synchronization signal broadcasted from a coordinator, includes a plurality of data devices linked to the wireless network each transmitting to the coordinator a command requesting a first channel time necessarily required and a second channel time selectively required according to a type of data to be transmitted, the coordinator allocating a channel time which includes a channel time allocation (CTA) period corresponding to each first channel time requested by the plurality of the devices, and a shared CTA period corresponding to each second channel time requested by the plurality of the devices and to be shared and used by the plurality of the devices, and broadcasting to the plurality of the devices the synchronization signal to which information of the allocated channel time is inserted.

### CROSS-REFERENCE TO RELATED APPLICATIONS

This application claims the benefit under 35 U.S.C. § 119(a) from Korean Patent Application No. 2003-99745, filed Dec. 30, 2003 in the Korean Intellectual Property Office, the disclosure of which is incorporated herein by reference in its entirety.

### BACKGROUND OF THE INVENTION

1. Field of The Invention

The present invention relates generally to a channel time allocation method. More particularly, the present invention pertains to a channel time allocation method which can provide quality of service (QoS) when a channel error occurs, and efficiently support a variable bit rate such as MPEG-2 video.

2. Description of The Related Art

In contrast to a Local Area Network (LAN) or a Wide Area Network (WAN), a Personal Area Network (PAN) is a network owned by an individual person. Devices owned by the individual person are interconnected to construct the network to provide convenience for the owner. The wireless implementation of the PAN is a Wireless Personal Area Network (WPAN).

The Institute of Electrical and Electronics Engineers, Inc. (IEEE) 802.15 Working Group developed standards to implement short distance wireless networks. The Working Group has four Task Groups responsible for four standards. The IEEE 802.15.1 standard is the well-known Bluetooth, the IEEE 802.15.3 and IEEE 802.15.3a standards are for implementing high rate WPANs, and the IEEE 802.15.4 standard, alias Zigbee, is for low rate WPANs less than 250 kbps.

FIG. 1 is a diagram illustrating a configuration of a conventional wireless personal area network. Referring to FIG. 1, a plurality of data devices (DEV) 10 through 50 configures a piconet in the WPAN environment. The DEV 50 is a piconet coordinator (hereinafter, refer to as ‘PNC’).

The PNC 50 broadcasts a beacon, which is a synchronization signal, to the other data devices DEV1 10, DEV2 20, DEV3 30 and DEV4 40, and synchronizes the DEVs linked to the piconet. FIG. 2 illustrates the structure of a superframe which is used in a WPAN complying with a standard that is an improvement of the IEEE 802.15.3 or IEEE 802.15.3a standard (hereinafter, referred to as IEEE 802.15.3x).

It is noted that Carrier Sense Multiple Access with Collision Avoidance (CSMA/CA) scheme, which is widely used, cannot provide quality of service (QoS) in IEEE 802.15.3x high rate WPAN. Hence, a Channel Time Allocation (CTA) scheme, similar to a Time Division Multiple Access (TDMA) scheme, is introduced. In detail, a channel time to be used by a DEV is transmitted to the PNC through a channel time request command during a contention access period (CAP). The PNC examines and schedules the channel time request command and broadcasts the scheduled result, as shown in FIG. 3, to the DEVs through CTA IE (Information Element(s)) of a beacon frame. The DEVs transmit and receive data in a channel period allocated to each DEV. Since the period allocated by the PNC is used only by the corresponding DEV, QoS is allowed.

The channel time requested by a DEV to the PNC includes two types. One is an isochronous stream for transmitting a multimedia stream, and an asynchronous channel time for transmitting bulk data.

In transmitting the isochronous stream, a DEV requests periodically a channel time. When the channel time requested by the DEV is not available or a priority is unsupported for the DEV, the PNC rejects the request. Otherwise, the PNC allocates the channel time.

In transmitting the asynchronous channel time, a DEV does not request a channel time periodically but requests a total time that is sufficient to transmit a bulk data. The PNC allocates a channel time for the DEV and maintains a time which is the result of subtracting the allocated channel time from the requested total time, to allocate the time for a next request. When the PNC cannot accept the channel time request, the PNC queues the request.

However, according to the conventional channel time allocation method, if channel status deteriorates and a frame error or damage is introduced, a frame to be transmitted is not transmitted completely, thus degrading QoS. As shown in FIG. 4, when an error occurs in 3 frames of the isochronous stream, more channel time needs to be allocated to transmit the 3 frames. Meanwhile, more channel time would be allocated if additionally required time for the re-transmission due to channel error were to be accurately predicted, but this is not possible in actual practice.

A variable bit rate (VBR) stream has a data rate which varies according to every transmission. As shown in FIG. 5A, if a channel time is allocated based on a peak data rate consistent with an I frame, then the B frame and P frame have unused channel time. If a channel time is allocated based on an average data rate, the I frame lacks adequate channel time for transmission as shown in FIG. 5B. Accordingly, network utilization decreases in the VBR stream for the sake of QoS.

Furthermore, the conventional channel time allocation method cannot support a high layer reliable protocol. For example, when TCP is used on MAC, TCP ACK is transmitted in a data frame. Accordingly, bidirectionality can be allowed on the MAC by allocating 2 unidirectional CTAs. If the high layer reliable protocol uses a flow control, a transmission quantity from a source to a destination and a transmission quantity from a destination and a source varies according to time. As a result, it is difficult to allocate the channel time in the above case.

### SUMMARY OF THE INVENTION

An aspect of the present invention is to provide a channel time allocation method which can support QoS even when a channel error is introduced in WPAN and support a VBR stream or a high layer reliable protocol without degrading network utilization.

According to an aspect of the present invention, the channel time allocation in a wireless network which is synchronized by a synchronization signal broadcasted from a coordinator, includes a plurality of data devices linked to the wireless network each transmitting to the coordinator a command requesting a first channel time necessarily required and a second channel time selectively required according to a type of data to be transmitted, the coordinator allocating a channel time which includes a channel time allocation (CTA) period corresponding to each first channel time requested by the plurality of the devices, and a shared CTA period corresponding to each second channel time requested by the plurality of the devices and to be shared and used by the plurality of the devices, and broadcasting to the plurality of the devices the synchronization signal to which an information of the allocated channel time is inserted. The method further includes transmitting and receiving data between the plurality of the devices within a period which is set based on the information inserted in the synchronization signal, relating to the allocated channel time. The wireless network may be a wireless personal area network (WPAN).

The type of the transmitted data may be one of a first data type for transmitting an isochronous multimedia stream and a second data type for transmitting an asynchronous bulk data. The second channel time may be one of a time allocated for a retransmission when a channel error occurs, and a time allocated according to characteristics of a variable bit rate (VBR) stream among the first data type.

The command requesting the channel time allocation may be a channel time request command including an information corresponding to the first and second channel times. The allocated channel information may be included in a shared CTA IE (Channel Time Allocation Information Element) which is in a beacon frame to be used as the synchronization signal. The shared CTA IE may include at least one of fields indicating information on the number of devices using the shared CTA, a channel access method, a queue time for the channel access, and whether to access the channel after checking an idle state of the channel. The access method may be one of a method through an implicit channel sensing which accesses a channel when a set condition and a time are satisfied, and a method through an explicit channel sensing which accesses a channel after receiving a notification that the channel is not being used, from the device using the shared CTA.

### BRIEF DESCRIPTION OF THE DRAWING FIGURES

These and/or other aspects and advantages of the invention will become apparent and more readily appreciated from the following description of the embodiments, taken in conjunction with the accompanying drawing figures of which:

FIG. 1 is a diagram illustrating a configuration of the conventional WPAN;

FIG. 2 is a diagram illustrating a structure of a superframe complying with the IEEE 802.15.3 standard;

FIG. 3 is a diagram illustrating a structure of CTA IE;

FIG. 4 is a diagram illustrating the conventional channel time allocation method, in which a channel error is introduced;

FIGS. 5A and 5B are diagrams illustrating the conventional channel time allocation method, in which the VBR stream is transmitted;

FIG. 6 is a diagram illustrating a channel time allocation method according to an embodiment of the present invention;

FIG. 7 is a message sequence chart illustrating exemplary steps of the channel time allocation method according to an embodiment of the present invention;

FIG. 8 is a diagram illustrating a structure of a channel time request command used in the channel time allocation method according to an embodiment of the present invention;

FIG. 9 is a diagram illustrating a structure of a shared CTA IE used in the channel time allocation method according to an embodiment of the present invention;

FIG. 10 is a diagram illustrating a channel access by an explicit channel sensing; and

FIGS. 11 and 12 are diagrams illustrating exemplary effects of the channel time allocation method according to an embodiment of the present invention.

### DETAILED DESCRIPTION OF THE EXEMPLARY EMBODIMENTS

Reference will now be made in detail to the embodiments of the present invention, examples of which are illustrated in the accompanying drawing figures, wherein like reference numerals refer to like elements throughout. The embodiments are described below in order to explain the present invention by referring to the drawing figures.

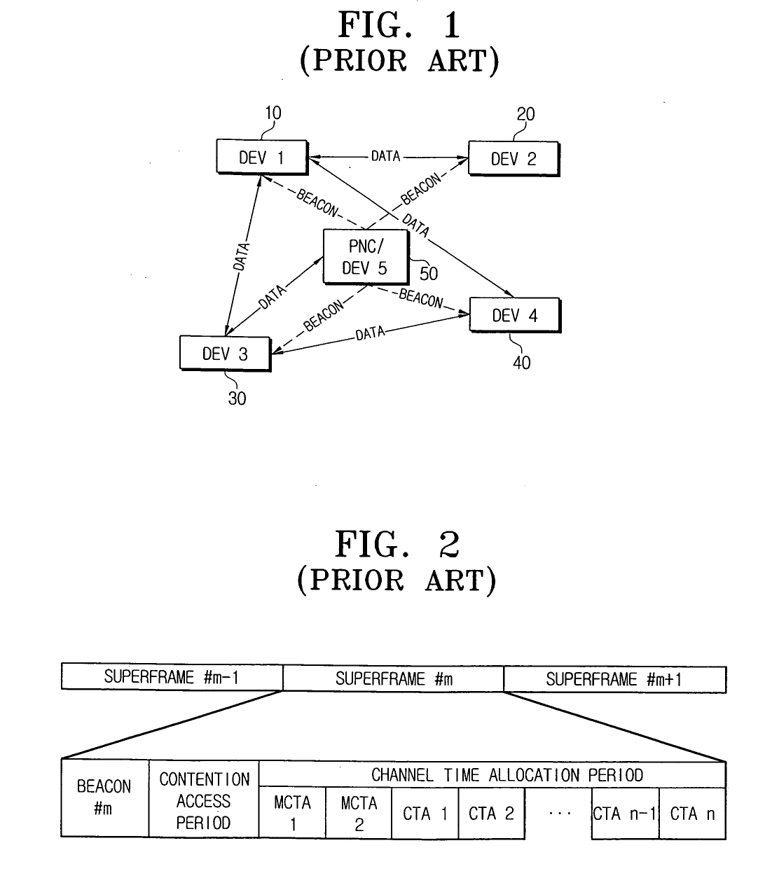

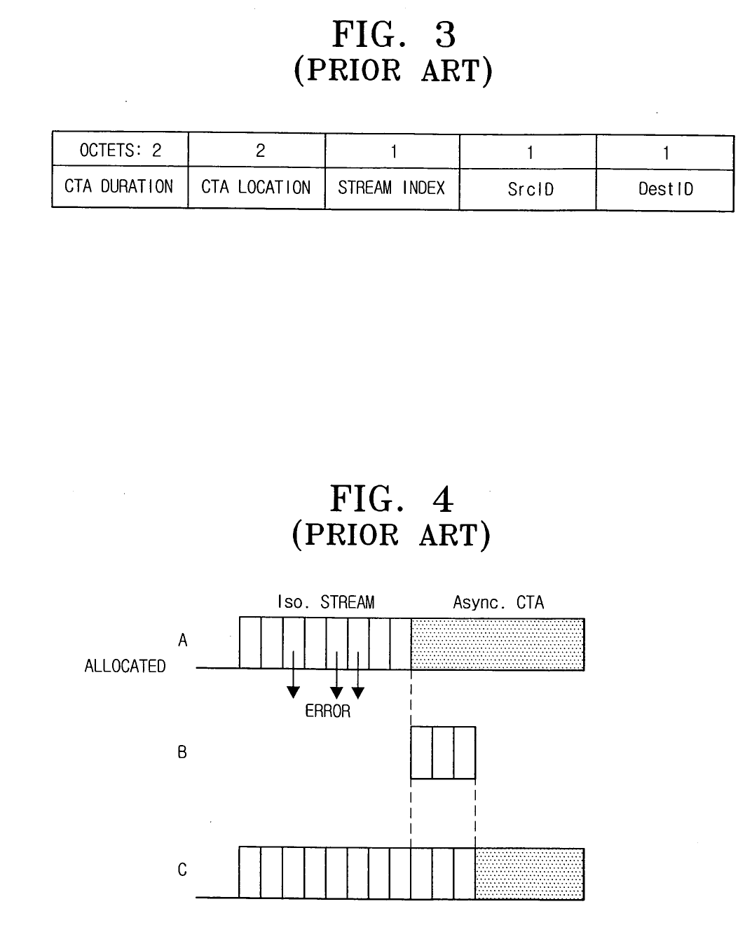

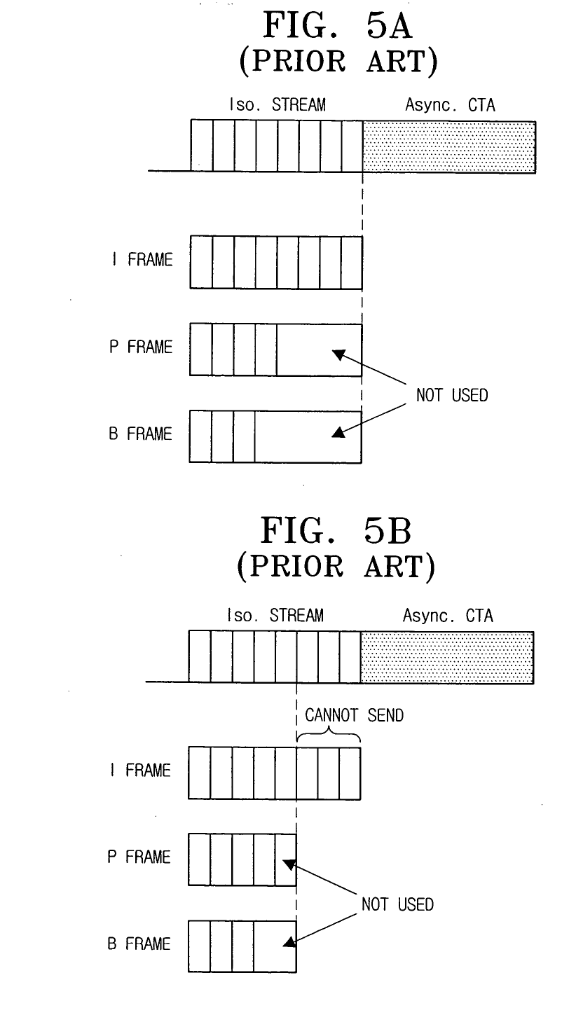

A channel time allocation method in a wireless personal area network (WPAN) according to an embodiment of the present invention is applied to a WPAN based on the IEEE 802.15.3 standard, but the present invention is not limited to the specifics of this embodiment. The channel time allocation method may be applied to any other wireless network environments appropriate to the teaching herein. Understanding the present invention will be facilitated by referring to FIG. 1 which illustrates the configuration of a conventional WPAN. Elements having the same function and structure as the elements shown in FIG. 1, will be given the same reference numerals.

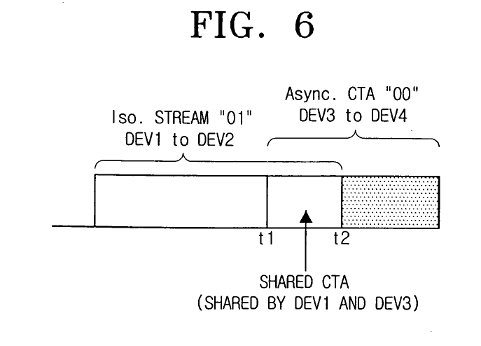

FIG. 6 is a diagram illustrating the channel time allocation method according to an embodiment of the present invention. Referring to FIG. 6, the channel time allocation method allocates a channel time so that more than two data devices (DEVs) can share a single channel time allocation (CTA), as opposed to a situation where a DEV exclusively uses the allocated CTA. A period until t1 is allocated to transmit an isochronous stream from DEV1 10 to DEV2 20, and a period from t2 is allocated as an asynchronous channel time to transmit a bulk data from the DEV3 30 to the DEV4 40. A period between t1 and t2 is allocated as a shared CTA for the DEV1 10 and the DEV3 30. Although the DEV1 10 has the higher priority, that is, a lower short interframe space (SIFS) value, of using the channel, the DEV3 30 may use the period between t1 and t2 when a channel error is not introduced and the shared CTA is not necessary. Thus, QoS is provided when the channel error is introduced, and network utilization is prevented from degrading by enabling the DEVs to use the shared CTA period.

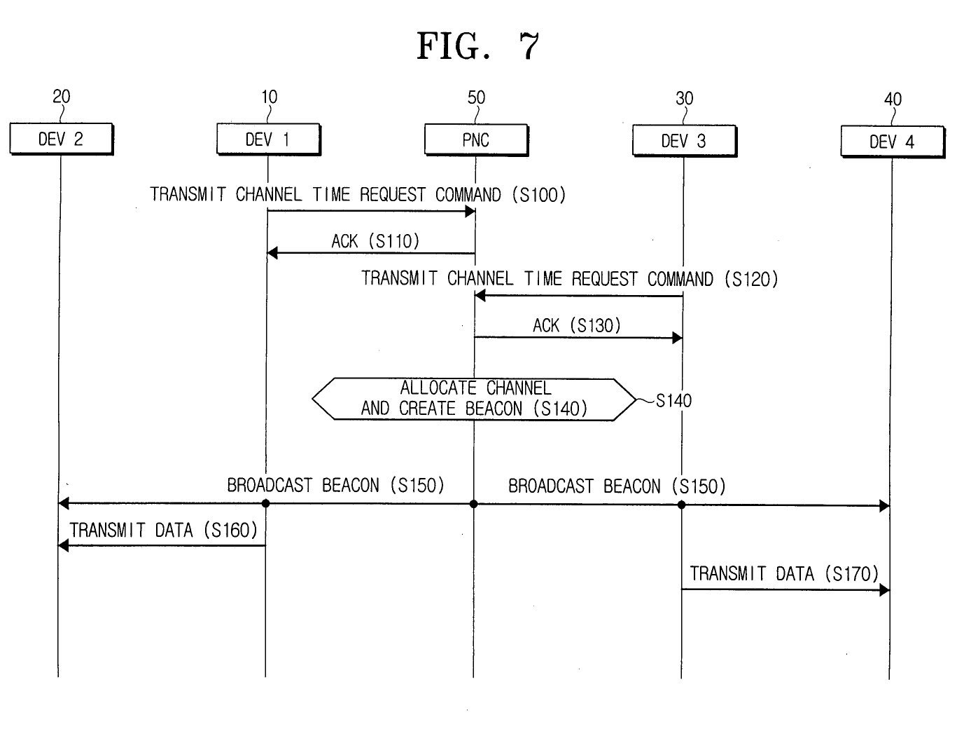

FIG. 7 is a message sequence chart illustrating exemplary steps of the channel time allocation method according to an embodiment of the present invention. Referring to FIG. 7, the DEV1 10 transmits a channel time request command to the PNC 50 (S100), and accordingly, the PNC 50 transmits an ACK signal to the DEV1 10 (S110). In the same manner, the DEV3 30 transmits a channel time request command to the PNC 50 (S120), and accordingly, the PNC 50 transmits an ACK signal to the DEV3 30 (S 130).

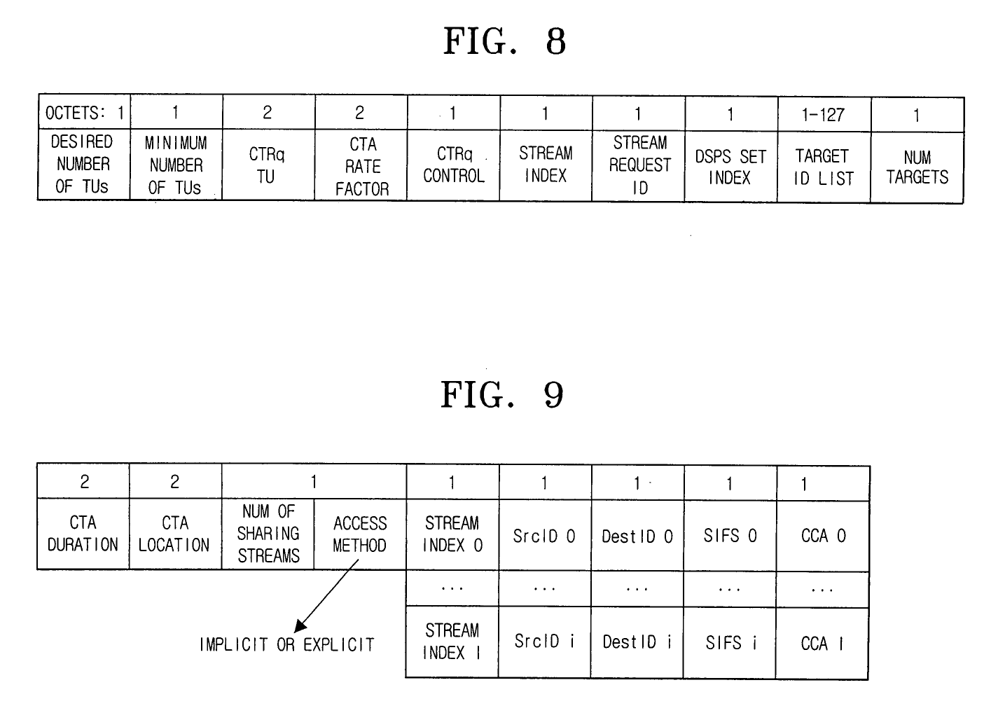

The channel time request command transmitted to the PNC 50 from the DEV1 10 or the DEV3 30, has basically the same structure, as shown in FIG. 8, as that of the IEEE 802.15.3x standard, but uses different interpretation on some fields. Specifically, for an isochronous stream, the Desired Number Of TUs field indicates a requested channel time by referencing a desired retransmission quantity necessary due to the variable quantity according to the VBR stream and the channel error. The Minimum Number Of TUs field stores the required channel time. For an asynchronous channel time, the total channel time required for the transmission is requested by dividing the total time into the Desired Number Of TUs and Minimum Number Of TUs fields. For a high layer reliable protocol such as the TCP, 4th bit of the CTRq Control field, which is a reserved bit, is set to ‘1’ for the distinction.

The PNC 50 allocates the channel time after examining the channel time requests of the DEVs, and creates beacons including information on the allocated channel times (S140). The PNC 50 broadcasts the created beacons (S150). FIG. 9 illustrates the shared CTA IE included in the information of the beacon broadcasted from the PNC 50.

Referring to FIG. 9, the shared CTA IE used in an embodiment of the present invention further includes Num Of Sharing Streams and Access Method fields as well as Stream Index[i], SrcID[i], DestID[i], SIFS[i] and CCA[i] fields as many in proportion to the number of DEVs sharing the shared CTA period. The SIFS[i] field indicates time information of each DEV waiting for the channel use. When the CCA[i] field is ‘1’, the corresponding DEV can use the channel after the channel becomes idle after the SIFS[i] period. When the CCA[i] field is ‘0’, the corresponding DEV can use the channel after the SIFS[i] period without having to check the channel status.

The Access Method field indicates information which instructs using any one of channel access methods through an implicit channel sensing or an explicit channel sensing. In an embodiment of the present invention, both channel access methods through the implicit and explicit channel sensings are available. In the foregoing, the channel access method through the implicit channel sensing is that when the CCA[i] field is ‘1’, the channel is used after the channel becomes idle after the SIFS[i] period, and when the CCA[i] field is ‘0’, the channel is used after the SIFS[i] period. The channel access method through the implicit channel sensing is utilized if the PNC determines that hidden terminal problems do not arise between the shared DEVs.

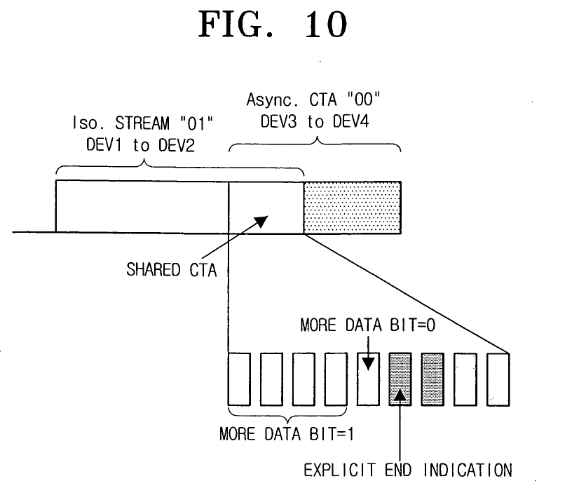

Meanwhile, the channel access method through the explicit channel sensing is utilized if the PNC determines that hidden terminal problems arise between shared DEVs. In the channel access method through the explicit channel sensing, a DEV using the channel explicitly shows that the channel is not used any more. As shown in FIG. 10, if the DEV1 10 does not use the channel any more in the shared CTA period, the DEV1 10 sets More Data bit to ‘0’ and transmits the More Data bit to the DEV2 20. On receiving the More Data bit, the DEV2 20 notifies the PNC 50 of the More Data bit. The PNC 50 notifies the DEV3 30, which is the next to use the channel, that the channel is not being used. As a result, the DEV3 30 can use the channel.

When the beacons are broadcasted from the PNC 50 (S150), the DEV1 10 and DEV3 30 each transmits the data using a set channel time by referencing the shared CTA IE included in the beacon (S160). The DEV1 10 initially uses the shared CTA period. When the channel error does not arise and the shared CTA period is not necessary, the DEV3 30 uses the shared CTA period.

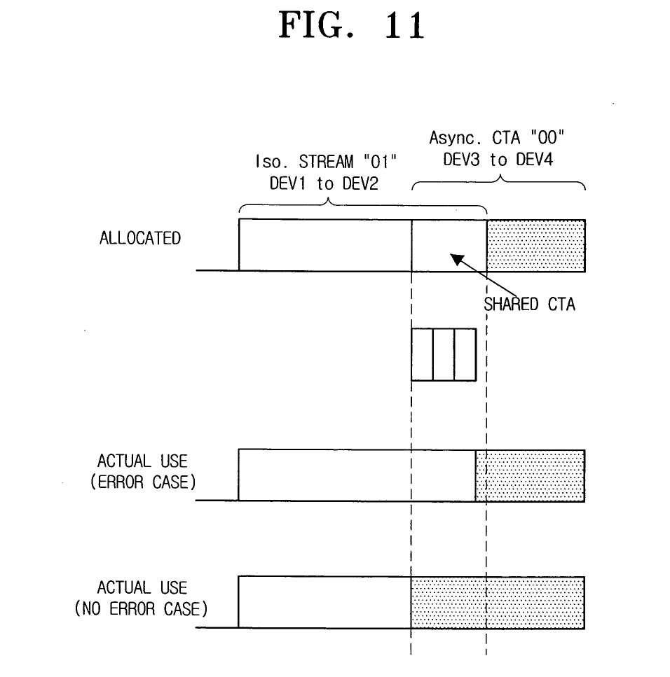

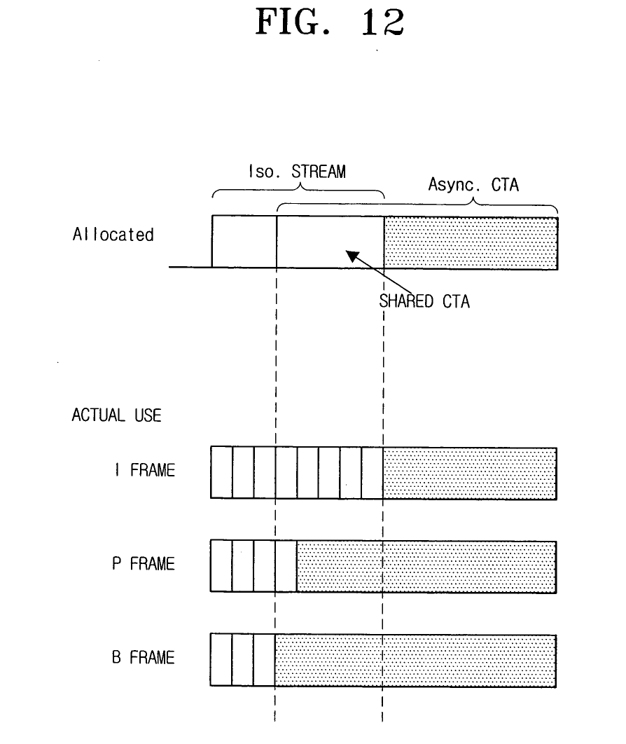

FIGS. 11 and 12 illustrate exemplary effects of the channel time allocation method according to an embodiment of the present invention. Referring to FIG. 11, the QoS of the isochronous stream is ensured no matter how the channel status actually changes when the isochronous stream and the asynchronous channel time share the shared CTA period. If it is assumed that three frame errors or damages are introduced by the channel error, the isochronous stream has the priority within the shared CTA period and transmits three erroneous frames (error case). If it is assumed that the channel status is normal and the channel error does not arise, the asynchronous channel time uses the shared CTA period. As a result, the network utilization does not deteriorate (no error case).

FIG. 12 illustrates an exemplary case that the shared CTA period is used to transmit the VBR stream so that the QoS is ensured and the network utilization does not deteriorate. In detail, an I frame is transmitted using the entire shared CTA period, and a P frame or a B frame is transmitted selectively using the shared CTA period if necessary. As a result, the QoS is provided and the network utilization is maintained.

In addition, the channel time allocation method according to an embodiment of the present invention efficiently supports the high layer reliable protocol. For example, the shared CTA is allocated so that a TCP source device and a TCP destination device can share the shared CTA. The source device transmits data after the SIFS period, the destination device transmits TCP ACK after the channel status becomes idle after SIFS+α by using the CCA field. Although the number of TPC segments transmitted from the source devices varies according to the TCP flow control, a series of segments is transmitted, a TCP ACK is received, a series of segments is transmitted, and a TCP ACK is received within a single shared CTA. Thus, the network utilization is improved as compared with the method allocating two unidirectional CTAs.

According to an embodiment of the present invention, the shared CTA is allocated so that a plurality of DEVs can use the CTA, to thus provide the QoS even if a channel error arises. Also, the QoS of the VBR stream can be allowed using the shared CTA and the high layer reliable protocol such as the TCP can be efficiently supported without degrading the network utilization.

While the embodiments of the present invention have been described, additional variations and modifications of the embodiments may occur to those skilled in the art once they learn of the basic inventive concepts. Therefore, it is intended that the appended claims shall be construed to include both the above embodiments and all such variations and modifications that fall within the spirit and scope of the invention.

1. A channel time allocation method in a wireless network which is synchronized by a synchronization signal broadcasted from a coordinator, comprising the steps of:
a plurality of data devices linked to the wireless network each transmitting to the coordinator a command requesting a first channel time necessarily required and a second channel time selectively required according to a type of data to be transmitted;
the coordinator allocating a channel time which includes a channel time allocation (CTA) period corresponding to each first channel time requested by the plurality of the devices, and a shared CTA period corresponding to each second channel time requested by the plurality of the devices and to be shared and used by the plurality of the devices; and
broadcasting to the plurality of the devices the synchronization signal to which information of the allocated channel time is inserted.

2. The method of claim 2, further comprising transmitting and receiving data between the plurality of the devices within a period which is set based on the information inserted in the synchronization signal, relating to the allocated channel time.

3. The method of claim 1, wherein the wireless network is a wireless personal area network (WPAN).

4. The method of claim 3, wherein the type of data to be transmitted is one of a first data type comprising an isochronous multimedia stream and a second data type comprising asynchronous bulk data and a first channel time allocation method is used for data of the first type and a second channel time allocation method is used for data of the second type.

5. The method of claim 4, wherein the second channel time is one of a time allocated for a retransmission when a channel error occurs, and a time allocated according to characteristics of a variable bit rate (VBR) stream among the first data type.

6. The method of claim 4, wherein the command requesting the channel time allocation is a channel time request command including information corresponding to the first and second channel times.

7. The method of claim 4, wherein the allocated channel information is included in a shared CTA IE (Information Element(s)) which is in a beacon frame used as the synchronization signal.

8. The method of claim 7, wherein the shared CTA IE includes at least one of fields indicating information on the number of devices using the shared CTA, a channel access method, a queue time for the channel access, and whether to access the channel after checking an idle state of the channel.

9. The method of claim 8, wherein the access method is one of a method through an implicit channel sensing which accesses a channel when a set condition and a time are satisfied, and a method through an explicit channel sensing which accesses a channel after receiving a notification that the channel is not being used, from the device using the shared CTA.
